(19) United States
(12) Patent Application Publication
(10) Pub. No.: US 2013/0338384 A1
(43) Pub. Date: Dec. 19, 2013

(54) PROCESS FOR THE RELEASE OF LIPIDS FROM MICROALGAE

(71) Applicants: Karin Bus, Amsterdam (NL); Johannes Pieter Haan, Amsterdam (NL); Johannes Leendert Willem Cornelis Den Boestert, Amsterdam (NL); Jose Luis Bravo, Houston, TX (US)

(72) Inventors: Karin Bus, Amsterdam (NL); Johannes Pieter Haan, Amsterdam (NL); Johannes Leendert Willem Cornelis Den Boestert, Amsterdam (NL); Jose Luis Bravo, Houston, TX (US)

(21) Appl. No.: 13/995,194

(22) PCT Filed: Dec. 19, 2011
(86) PCT No.: PCT/EP2011/073294

§ 371 Date: Sep. 4, 2013

Related U.S. Application Data
(60) Provisional application No. 61/424,853, filed on Dec. 20, 2010.

(51) Int. Cl. C11B 3/00

(52) U.S. Cl. CPC C11B 3/006
USPC 554/206; 554/175; 585/14; 585/310

(57) ABSTRACT

The present invention provides a process for the release of lipids from lipid-containing microalgae feedstock, comprising heating the lipid-containing microalgae feedstock to a temperature of more than 80 to 120° C. and at a pressure of from 1 to 5 bar (absolute).

### FIELD OF THE INVENTION

The present invention relates to a process for the release of lipids from lipid-containing microalgae, suitably for a subsequent extraction.

### BACKGROUND OF THE INVENTION

Microalgae, also referred to as microphytes, include microscopic microbial algae occurring both in freshwater and marine systems. Microalgae typically are unicellular species, which may exist as individual cells, or organized in n chains or groups. Depending on the species, sizes of microalgae can range from a few millimeters to a few micrometers (pm).

Microalgae perform photosynthesis, and grow photoautotrophically, producing products like terpenes, sugars, polypeptides, and lipids.

The chemical composition of microalgae products varies depending on species and on cultivation conditions. The term “microalgae lipids”, or short, “lipids”, refers to monoglycerides, diglycerides and triglycerides, free fatty acids, and other fatty acid esters, such as phospholipids and glycolipids present in microalgae.

Microalgae have high growth rates, utilise a large fraction of solar energy and can grow in conditions that are not favourable for terrestrial biomass. They have thus been recommended as a renewable source for the production of fuels and chemicals, using the lipids, terpenes and/or sugars of the microalgae. However, microalgae grow in relatively low concentrations in aqueous media, which requires concentration for production purposes, as well as removal of the water in the cells. Furthermore, solvent extraction of micro-algae, prior to cell disruption/cell wall weakening, can be very inefficient. Current cell disruption methods, such as for instance using a French press or a liquid homogenizer are very energy intensive, thereby strongly reducing the efficiency of the process. Lysing of microalgae is therefore usually required prior to any extraction process.

US2009/0081742 discloses a system and method for the creation of biofuel from oil in algae. In the system and method, algae cells are contacted in a cell lysis unit with live steam to rupture algae cells and to release the intracellular oil. The incoming algae feed is preheated in a heat exchanger by the stream from the steam treatment from about 20 to about 80° C. prior to entering the cell lysis unit.

A disadvantage of the disclosed steam treatment is the increase in water content after initially most intercellular water had been removed, thereby decreasing again the concentration of the lipids and increasing size and energy consumption of extractions steps subsequent to the steam treatment.

### SUMMARY OF THE INVENTION

Accordingly, the present invention provides in one embodiment a process for the release of lipids from lipid-containing microalgae feedstock, comprising heating the lipid-containing microalgae feedstock to a temperature of more than 80 to 150° C. ad at a pressure of from 1 to 5 bar(absolute).

### DETAILED DESCRIPTION OF THE INVENTION

Applicants have found that by such mild heat treatment, microalgae release the majority of the lipids present in the microalgae. Without wishing to be bound to any particular theory, it is believed that the cell walls appear to may remain largely intact, however pores in the cell wall may be opened, thus releasing at least part of the contents microalgae cells. This has been particular helpful for microalgae with crystalline cell walls, such as diatomic microalgae.

Microalgae can be cultivated under difficult agro-climatic conditions, including cultivation in freshwater, saline water, moist earth, dry sand and other open-culture conditions known in the art. The microalgae can also be cultivated and genetically engineered in controlled closed-culture systems, for example, in closed bioreactors. Preferably, microalgae used in the present invention are marine microalgae cultivated in fresh water, saline water or other moist conditions, more preferably marine microalgae cultivated in saline water.

Yet more preferably, the marine microalgae are cultivated in open-culture conditions, for example, in open ponds. These marine microalgae can include members from various divisions of algae, including diatoms, pyrrophyta, ochrophyta, chlorophyta, euglenophyta, dinoflagellata, chrysophyta, phaeophyta, rhodophyta and cyanobacteria. Preferably, the marine microalgae are members from the diatoms or ochrophyta division, more preferably from the raphid, araphid, and centric diatom family. Microalgae are typically harvested by sedimentation and/or flocculation, thus forming a microalgae sludge that can further processed.

Lipids as referred to in the present invention are a group of naturally occurring compounds that are usually hydrophobic in nature and contain long-chain aliphatic hydrocarbons and their derivatives such as fatty acids, alcohols, amines, amino alcohols and aldehydes. These lipids include monoglycerides, diglycerides and triglycerides, which are esters of glycerol and fatty acids, phospholipids, which are esters of glycerol and phosphate group-substituted fatty acids, and glycolipids which are esters of fatty acids and sugars.

The fatty acid moiety in the lipids released according to the invention preferably ranges from 4 carbon atoms to 30 carbon atoms, and includes saturated fatty acids containing one, two or three double bonds. Preferably, the fatty acid moiety includes 8 carbon atoms to 26 carbon atoms, more preferably the fatty acid moiety includes 10 carbon atoms to 25 carbon atoms, again more preferably the fatty acid moiety includes 12 carbon atoms to 23 carbon atoms, and yet more preferably 14 carbon atoms to 20 carbon atoms. The lipids may contain variable amounts of free fatty acids and/or esters, both of which may also be converted into hydrocarbons during the process of this invention. The lipids may be composed of natural glycerides only. The lipids may also include carotenoids, hydrocarbons, phosphatides, simple fatty acids and their esters, terpenes, sterols, fatty alcohols, tocopherols, polyisoprene, carbohydrates and proteins. It is to be understood that for the purpose of this invention, a mixture of lipids extracted from different microalgae sources can also be used as the lipid-containing feedstock.

Preferably, the lipid-containing feedstock includes lipids in the range of 1 wt % to 50 wt %, more preferably in the range of 2 wt % to 40 wt %, more preferably in the range of 3 wt % to 30 wt %, and yet more preferably in the range of 5 wt % to 20 wt %.

The microalgae feedstock that is employed in the process according to present invention may be a microalgae suspension as obtained from cultivation media. However, preferably, this suspension is first concentrated to reduce the volume of material that needs to be heated. This may advantageously involve cultivation of the microalgae, sedimentation and/or floculation or filtration of the microalgae, and a further concentration of the obtained lipid-containing microalgae feedstock. The term “lipid-containing microalgae feedstock” thus refers to microalgae comprising lipids in their cells, as well as to the sediment, sludge or slurry or filter cake as obtained from any of the above processes.

In step (a), the lipid-containing microalgae feedstock is heated to a temperature of more than 80 to 150° C., preferably of from 90 to 120° C. Preferably, the feedstock is heated under a pressure of from 1 to 5 bar(a), more preferably of from 3 to 4 bar (a). The heating may be performed batch-wise or preferably continuously.

Heating may be performed by any suitable means. Preferably the heating is performed by means that permit a suitable heat exchange, such as a heat exchanger, heated reactor walls, heated baffles, or directly through microwave, sunlight or any other heat-inducing source.

Preferably the heat is supplied by steam or a heating fluid. The steam or heated fluid preferably is heated at least in part through the use of solar heating. Since the temperature range in the heating step is rather low as compared to industrial quality superheated steam, the heat supplied through solar power thermal systems such as those disclosed in WO200102780 and WO2007118223 may be advantageously used to reduce the carbon footprint of the process according to the invention further. This heat may preferably also be employed for any step in the lipid recovery process.

The reactor may be any reactor capable of moving a highly viscous paste. Including extruder, screw presses, but also reactors with good stirring.

The specific reactor may be selected by a skilled person depending on the heat transfer required, the viscosity and/or solids content of the microalgae feed, and other factors such as cleaning and reliability. The reaction preferably is performed in absence of oxygen to reduce oxidative process that could reduce the amount of product obtained.

The process may be carried out in a continuous, semi-continuous or batch wise production. Preferably the process is conducted in a continuous manner.

The residence time of the microalgae feed in the reactor depends on the temperature and time required to release the lipids. Ideally, the time will be selected as short as possible.

A further effect of the heating is that peptides present in the microalgae tend to coagulate and precipitate, which permits to remove them as a further valuable products. Such peptides may advantageously be employed as fish or animal feed, replacing for instance fish meal.

The process may further comprise a solvent extraction in order to selectively remove the thus released lipids, by preferably (b) contacting the mixture obtained in (a) with a solvent to remove the released lipids. This is preferably performed by subjecting the heat-treated microalgae mixture obtained from step (a) to a filtration in the presence of a first extraction solvent on a wash filter, wherein organic matter soluble in an extraction solvent is removed as filtrate from a retentate comprising non-soluble matter; and (b) separating the filtrate obtained from the filter into an organic and aqueous phase; and (c) subjecting the organic phase to a distillation treatment to separate solvent and an organic residue comprising extracted lipids.

Preferably, the microalgae lipid-containing feedstock is subjected to a centrifugation prior to step (a) to a dry matter content of from 20 to 25% wt. prior to step (a) to avoid having to remove larger amounts of water after step (a). Preferably the mixture obtained in step (a) is subjected to a mechanical de-watering treatment, preferably centrifugation, to a dry matter content of from 25-50% wt. Again, this will further reduce the amount of water that needs to be removed in the process.

In step (b), the mixture obtained in (a) is preferably subjected to a filtration in the presence of a first extraction solvent on a wash filter, wherein organic matter soluble in an extraction solvent is removed as filtrate from a retentate comprising non-soluble matter.

In step (b), the mixture obtained in (a) is preferably subjected to a filtration in the presence of a first extraction solvent on a wash filter, wherein organic matter soluble in an extraction solvent is removed as filtrate from a retentate comprising non-soluble matter.

The filter will be such that it permits filtration of the cell remnants. Preferably the filter is chosen such that it is able to separate solids having mean diameters of from 50 to 10 micrometers as retentate from the filtrate. More preferred are filters that can be cleaned from retained sludge, e.g. by counter current injection of the filtrate, e.g. through flow inversion, such as for instance rotating screen filters. A pressure drop may preferably be applied to increase flow rates through the filter.

The microalgae slurry obtained in step (a), preferably having a dry matter content of between 5 to 20% wt. content, is advantageously fed between two counter rotating cylinders. The cylinders are placed very close to each other; preferably having a very small gap of less than 2 micrometers. This will advantageously press the cells and squeeze cell contents out. The counter rotating cylinders preferably are made of a porous abrasive resistant material, such as silicon carbide. The pore size of the rotating cylinders preferably is in the range of from 0.01 to 0.1 micrometers. Inside the rotating cylinders, a slight vacuum may be applied. This pressure difference will preferably transport the squeezed liquid originating from the cells inside the cylinders to where it is collected for further processing. Preferably, by selecting a hydrophilic or organophilic ceramic material for the cylinders, a preferential removal water or oily matter can be achieved, applying two or more process steps, e.g. in a first step, hydrophilic cylinders could be chosen to remove the bulk of the water, whilst thereafter oligophilic cylinders mainly remove the oily matter. To enhance the whole process the cylinders preferably may be heated at a range of from 50 to85 ° C. to lower the viscosity of the squeezed liquid, hence facilitating the transport through the porous wall of the rotating cylinders. The material not transported through the porous pressing cylinders will be mainly comprised of a solid with some residual water and oil. This material, protein rich, may preferably be dried for storage and transport, for use as fish or animal feed.

The filtration is preferably performed in the presence of a first extraction solvent.

Organic matter soluble in the extraction solvent is preferably removed as filtrate from a retentate comprising non-soluble matter.

In step (c), the filtrate obtained from the filter is preferably separated into an organic and aqueous phase. This may advantageously be done by one or more settler units, wherein the two phases are allowed to separate, or may include additional steps, e.g. removal of proteins such as lecithines, glyco- and phospholipids that may act as emulsifiers; degumming to remove polymeric material and similar well known process steps for the purification and refining of lipids feedstocks such as vegetable oils.

In an additional step (d), the organic phase can be subjected to a distillation treatment to separate solvent and an organic residue comprising extracted lipids.

Preferably, the subject process further comprises subjecting the aqueous phase obtained in (c) to a counter current extraction with a second extraction solvent to recover remaining organic material from the aqueous stream. More preferably, the obtained water stream may be sent to a bio-treater to allow the removal of any remaining solvents before discharging as cleaned process water. Alternatively, the water may preferably be recycled to the microbial lipid-containing feedstock growing system, such as algae farms or fermentor and bioreactors.

Preferably, the first and the second extraction solvent have a different polarity. Although this may require a separate distillation column, the benefit is due to the fact that the extraction/washing of the extracted lipids will occur from different matrices. This optional embodiment of the present invention may advantageously be used for optimisation in the process of recovering lipids.

Each solvent molecule is usually described by three Hansen Solubility Parameters, expressed in MPa^{0.5}. These are: δd for the energy from dispersion bonds between molecules; δp for the energy from polar bonds between molecules and δh for the energy from hydrogen bonds between molecules.

If the process according to the subject invention is performed with a single extraction solvent, as first and./or second solvent, the solvent Hansen solubility parameters of the solvent preferably are 14.5<δd<16; 0<δp<4.5; and 0<δh<5. Preferred extractant solvents may be single solvents or blends, preferably heptane and heptane/isopropanol blends.

If the process is performed with a first and second solvent that are different from each other, the Hansen solubility parameters of the first solvent preferably are:
δd of from 14.5 to 16;
δp of from 0 to 4.5; and
δh of from 0 to 5.

Preferably, the Hansen solubility parameters of the second solvent are:
δd of from 14.5 to 16;
δp of from 2.5 to 14.5; and
δh of from 2.5 to 16.

Preferred extractant solvents may be single solvents or blends, preferably heptane and heptane/isopropanol blends.

Preferably, the subject process further comprises subjecting the aqueous phase obtained in (c) to a counter current extraction with a second extraction solvent to recover remaining organic material from the aqueous stream. More preferably, the obtained water stream may be sent to a bio-treater to allow the removal of any remaining solvents before discharging as cleaned process water. Alternatively, the water may preferably be recycled to the feedstock cultivation system, such as algae farms or fermentors and bioreactors.

Preferably, the first and the second extraction solvent have a different polarity. Although this may require a separate distillation column, the benefit is due to the fact that the extraction/washing of the extracted lipids will occur from different matrices. This optional embodiment of the present invention may advantageously be used for optimisation in the process for recovering lipids.

Preferably, the first and the second extraction solvent have a different polarity.

The thus obtained organic residue preferably is subjected to a cleaning step. Such steps are well-known in the art, for instance as cleaning treatments for vegetable oils, involving acid or alkaline washing steps, removal of lecithines, phospho- and glucolipids to reduce the emulsion formation and catalyst poisoning tendencies; degumming, and removal of the peptides. Accordingly, the subject process preferably further comprising the steps of subjecting the organic residue to an optional cleaning step (i).

In step (d), the organic phase is subjected to a distillation treatment to separate solvent and an organic residue comprising extracted lipids. This may be performed in any suitable way known to a skilled person.

The process further preferably comprises contacting the cleaned residue with hydrogen in the presence of a hydrodeoxygenation catalyst to obtain a hydrodexygenated product stream comprising paraffins. The thus obtained p[product blend mainly comprises n-paraffins,. Which may not have sufficiently good cold flow properties for use as fuel components. Accordingly, the process preferably further comprises contacting the paraffins with hydrogen in presence of a suitable hydroisomerisation catalyst to obtain a product mixture comprising hydroisomerised paraffins. The paraffins, n- or iso-paraffins may be advantageously blended into a fuel composition, or used neat as fuel component. Typically fuel compositions comprise additives such as cold flow improvers, lubrication improvers, static dissipaters, and viscosity modifiers.

The invention will be illustrated by the following, non-binding example:

### Example 1

Five batches of slurries of a diatomic microalgae species having 20% wt. dry matter were heat treated in a Parr autoclave at the indicated temperature and time. Extraction yield, using a heptane/iso-propanol mixture as solvent, before and after heat treatment was determined (Table 1).

TABLE 1
extraction yields of untreated and heat treated micro-algae.

| | Yield | | | |
|---|---|---|---|---|
| | (% wt.) | | | |
| | No heat | Yield | Yield | Yield |
| | treatment | (% wt.) | (% wt.) | (% wt.) |
| Starting | No heat | 80° C. | 120° C. | 150° C. |
| material | treatment | 30 min | 30 min | 60 min |
| Batch 1 | 5.1 | 7.5 | 11.3 | n.d. |
| Batch 2 | 3.1 | n.d. | 6.2 | n.d. |
| Batch 3 | 3.8 | n.d. | 7.1 | n.d. |
| Batch 4 | 14.09 | n.d. | n.d. | 24.24 |
| Batch 5* | 2.94 | n.d. | n.d. | 18.54 |

*using only heptane as a solvent

Table 1 shows the extraction yield of the untreated algae (starting material) and differs from 3.1 to 5.1% wt. By applying a heat treatment for 30 minutes at 120° C. the extraction yield was nearly doubled in most cases.

1. A process comprising (a) heating the lipid-containing microalgae feedstock to a temperature of more than 80 to 150° C., and at a pressure of from 1 to 5 bar (absolute) to release at least a portion of lipids from a lipid-containing microalgae feedstock.

2. The process of claim 1, further comprising
(b) contacting the mixture obtained in (a) with a solvent to remove at least a portion of the released lipids.

3. The process of claim 2, wherein step (b) is comprises filtration in the presence of a first extraction solvent on a wash filter, wherein an organic matter soluble in an extraction solvent is removed as filtrate from a retentate comprising non-soluble matter.

4. The process of claim 3, further comprising
(c) separating at least a portion of the filtrate obtained from the filter in step (b) into an organic phase and an aqueous phase; and
(d) subjecting at least a portion of the organic phase to a distillation treatment to separate a solvent and an organic residue comprising an extracted lipid.

5. The process of claim 4, further comprising subjecting at least a portion the aqueous phase obtained in (c) to a counter current extraction with a second extraction solvent to recover at least a portion of remaining organic material from the aqueous stream.

6. The process of claim 1, wherein the heat is supplied at least in part from a solar thermal heat system.

7. The process of claim 1, wherein the solvent Hansen solubility parameters are 14.5<δd<16; 0<δp<4.5; and 0<δh<5.

8. The process of claim 6 wherein the first and the second extraction solvent have a different polarity.

9. The process of claim 6, wherein the Hansen solubility parameters of the first solvent are 14.5<δd<16; 0<δp<2.5; and 0<δh<2.5; and wherein the Hansen solubility parameters of the second solvent are 14.5<δd<16; 2.5<δp<14.5 and 2.5<δh<16.7.

10. The process of claim 1, wherein the microalgae comprises a marine microalgae.

11. The process of claim 4, further comprising subjecting at least a portion of the organic residue to cleaning step (i).

12. The process of claim 11, further comprising contacting the cleaned residue with hydrogen in the presence of a hydrodeoxygenation catalyst to obtain a hydrodexygenated product stream comprising paraffins.

13. The process of claim 12, further comprising contacting at least a portion of the paraffins with hydrogen in presence of a hydroisomerisation catalyst to obtain a product mixture comprising hydroisomerised paraffins.

14. The process of claim 12, wherein at least a portion of the paraffins is blended into a fuel composition.

15. The process of claim 10 wherein the marine microalgae comprises a diatomic microalgae.

16. The process of claim 13 wherein at least a portion of the paraffins is blended into a fuel composition.
